(19) United States
(12) Patent Application Publication
(10) Pub. No.: US 2014/0092504 A1
(43) Pub. Date: Apr. 3, 2014

(54) Electrostatic discharge protection device

(71) Applicant: MACRONIX INTERNATIONAL CO., LTD., Hsinchu (TW)

(72) Inventors: Shih-Yu Wang, Hsinchu (TW); Yao-Wen Chang, Hsinchu (TW); Tao-Cheng Lu, Hsinchu (TW)

(73) Assignee: MACRONIX International Co., Ltd., Hsinchu (TW)

(21) Appl. No.: 13/573,738

(22) Filed: Oct. 3, 2012

(51) Int. Cl. H02H 9/04

(52) U.S. Cl. CPC H02H 9/044
USPC 361/56

(57) ABSTRACT

An electrostatic discharge protection device including a silicon-controlled rectifier and a path switching circuit is provided. The silicon-controlled rectifier includes a first connection terminal, a second connection terminal, a first control terminal and a second control terminal, wherein the first connection terminal and the second connection terminal are respectively connected to a first line and a second line. The path switching circuit is electrically connected to the first line, the first control terminal and the second control terminal. When an input signal is supplied to the first line, the path switching circuit provides a first current path from the first line to the first control terminal in response to the input signal. When an electrostatic pulse is appeared on the first line, the path switching circuit provides a second current path from the first control terminal to the second control terminal in response to the electrostatic pulse.

### BACKGROUND

1. Technical Field

The invention relates to an electrostatic discharge protection device, and more particularly, to an electrostatic discharge protection device having a silicon-controlled rectifier.

2. Related Art

Electrostatic discharge (ESD) is generally a main reason that causes electrostatic overstress or permanent damage of an integrated circuit, so that an ESD protection device is added to the integrated circuit to prevent the damage caused by ESD.

In recent years, a silicon-controlled rectifier (SCR) has become a basic element in design of the ESD protection device. The SCR has a PNPN semiconductor structure, which can be equivalent to a circuit structure composed of a PNP transistor and an NPN transistor. In an actual application, when an ESD event occurs, avalanche breakdown between an N-type well and a P-type substrate of the PNPN semiconductor structure has to be first formed, and then the SCR can simultaneously turn on the PNP transistor and the NPN transistor through an avalanche breakdown current, so as to form a discharge path used for discharging an electrostatic pulse.

In other words, the existing SCR has to rely on the avalanche breakdown current in the PNPN semiconductor structure to simultaneously turn on the equivalent PNP transistor and NPN transistor. However, such turn on method generally decreases a turn-on speed of the SCR, which influences protection performance of the ESD protection device.

### SUMMARY

Accordingly, an embodiment of the invention provides an electrostatic discharge protection device, in which a path switching unit is used to control a current path of a silicon-controlled rectifier (SCR), which helps improving a turn on speed of the SCR.

An embodiment of the invention provides an electrostatic discharge protection device including a silicon-controlled rectifier and a path switching unit. The silicon-controlled rectifier includes a first connection terminal, a second connection terminal, a first control terminal and a second control terminal, wherein the first connection terminal and the second connection terminal are respectively connected to a first line and a second line. The path switching unit is electrically connected to the first line, the first control terminal and the second control terminal. When an input signal is supplied to the first line, the path switching unit provides a first current path from the first line to the first control terminal in response to the input signal. When an electrostatic pulse is appeared on the first line, the path switching unit provides a second current path from the first control terminal to the second control terminal in response to the electrostatic pulse.

According to an embodiment of the invention, the path switching unit includes a first switch, a second switch and a control circuit. The first switch is electrically connected between the first line and the first control terminal. The second switch is electrically connected between the first control terminal and the second control terminal. The control circuit is electrically connected to the first line, the second line, the first switch and the second switch. The control circuit turns on the second switch and turns off the first switch in response to the electrostatic pulse so as to provide the second current path through the second switch. Moreover, the control circuit turns on the first switch and turns off the second switch in response to the input signal so as to provide the first current path through the first switch.

According to an embodiment of the invention, the control circuit includes a capacitor and a resistor. A first terminal of the capacitor is electrically connected to the first line. A first terminal of the resistor is electrically connected to a second terminal of the capacitor, and a second terminal of the resistor is electrically connected to the second line. The control circuit generates a first control signal through the second terminal of the capacitor.

According to an embodiment of the invention, the first switch and the second switch are respectively composed of a P-type transistor and an N-type transistor, and the P-type transistor and the N-type transistor are respectively controlled by the first control signal.

According to an embodiment of the invention, the control circuit includes a first P-type transistor, a first N-type transistor, a second P-type transistor and a second N-type transistor. A source of the first P-type transistor is electrically connected to the first line. A drain of the N-type transistor is electrically connected to a drain of the first P-type transistor, a gate of the first N-type transistor is electrically connected to a gate of the first P-type transistor, and a source of the N-type transistor is electrically connected to the second line. A source of the second P-type transistor is electrically connected to the first line, a gate of the second P-type transistor is electrically connected to the drain of the first P-type transistor, and a drain of the second P-type transistor generates a first control signal and is electrically connected to the gate of the first P-type transistor. A drain of the second N-type transistor is electrically connected to the drain of the second P-type transistor, a gate of the second N-type transistor receives a power voltage, and a source of the second N-type transistor is electrically connected to the second line.

According to an embodiment of the invention, the control circuit further includes a capacitor, and a first terminal of the capacitor is electrically connected to the first line, and a second terminal of the capacitor is electrically connected to the gate of the first P-type transistor.

Another embodiment of the invention provides an electrostatic discharge protection device including a silicon-controlled rectifier and a path switching unit. The silicon-controlled rectifier includes a first connection terminal, a second connection terminal, a first control terminal and a second control terminal, wherein the first connection terminal and the second connection terminal are respectively connected to a first line and a second line. The path switching unit includes a first switch connected between the first line and the first control terminal and a second switch connected between the first control terminal and the second control terminal. When an input signal is supplied to the first line, the path switching unit turns on the first switch and turns off the second switch. When an electrostatic pulse is appeared on the first line, the path switching unit turns off the first switch and turns on the second switch.

According to an embodiment of the invention, the path switch unit further includes a control circuit. The control circuit is electrically connected to the first line, the second line, the first switch and the second switch. Moreover, the control circuit turns on the second switch and turns off the first switch in response to the electrostatic pulse, and the control circuit turns on the first switch and turns off the second switch in response to the input signal.

According to the above descriptions, the path switching unit is used to control the current paths of the silicon-controlled rectifier, such that the silicon-controlled rectifier can simultaneously turn on a PNP transistor and an NPN transistor without forming an avalanche breakdown current between an N-type well and a P-type substrate. In other words, when an ESD event occurs, a turn-on speed of the silicon-controlled rectifier is accelerated under control of the path switching unit, which avails improving protection performance of the electrostatic discharge protection device.

It is to be understood that both the foregoing general description and the following detailed description are exemplary, and are not intended to limit the scope of the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of an electrostatic discharge (ESD) protection device according to an exemplary embodiment of the invention.

FIG. 2 is an equivalent circuit diagram of an ESD protection device according to an exemplary embodiment of the invention.

FIG. 3 is a characteristic curve of an SCR according to an exemplary embodiment of the invention.

FIGS. 4-5 are respectively a structural schematic diagram of an SCR according to an exemplary embodiment of the invention.

FIGS. 6-8 are circuit schematic diagrams of path switching units according to an exemplary embodiment of the invention.

FIG. 9 is a schematic diagram of a control circuit according to an exemplary embodiment of the invention.

FIG. 10 is a circuit schematic diagram of a path switching unit according to another exemplary embodiment of the invention.

FIG. 11 is a schematic diagram of a control circuit according to another exemplary embodiment of the invention.

FIGS. 12-16 are respectively a circuit schematic diagram of a path switching unit according to still another exemplary embodiment of the invention.

### DETAILED DESCRIPTION OF DISCLOSED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

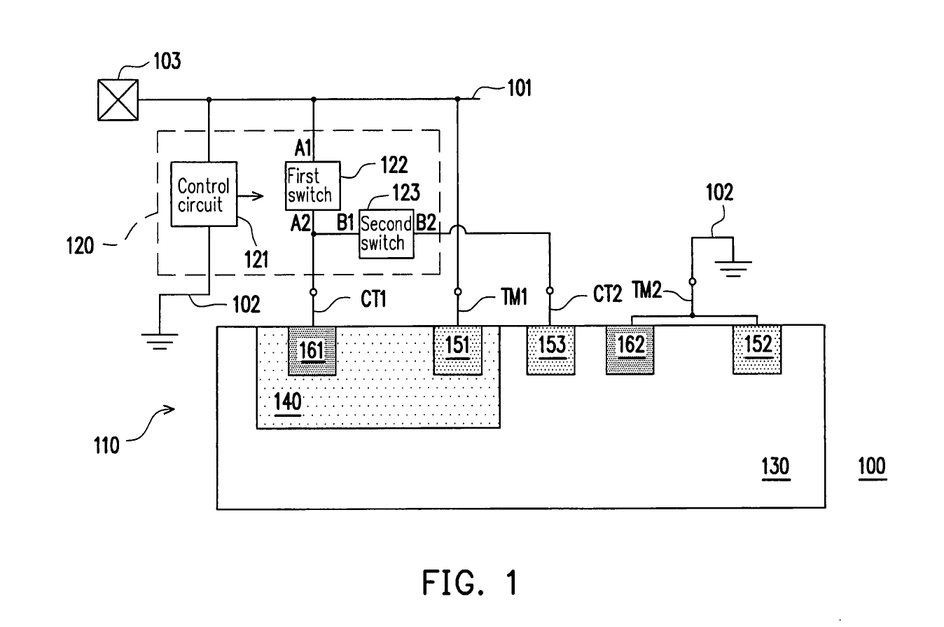

FIG. 1 is a schematic diagram of an electrostatic discharge (ESD) protection device according to an exemplary embodiment of the invention. Referring to FIG. 1, the ESD protection device 100 includes a silicon-controlled rectifier (SCR) 110 and a path switching unit 120. The SCR 110 includes a first connection terminal TM1, a second connection terminal TM2, a first control terminal CT1 and a second control terminal CT2. The path switching unit 120 includes a control circuit 121, a first switch 122 and a second switch 123.

Regarding the path switching unit 120, the first switch 122 is electrically connected between a first line 101 and the first control terminal CT1. In this way, when the first switch 122 is turned on, the first switch 122 provides a first current path from the first line 101 to the first control terminal CT1. The second switch 123 is electrically connected between the first control terminal CT1 and the second control terminal CT2. In this way, when the second switch 123 is turned on, the second switch 123 provides a second current path from the first control terminal CT1 to the second control terminal CT2. The control circuit 121 is electrically connected to the first line 101, a second line 102, the first switch 122 and the second switch 123, and controls the first switch 122 and the second switch 123.

Regarding the SCR 110, the SCR 110 is respectively connected to the first line 101 and the second line 102 through the first connection terminal TM1 and the second connection terminal TM2. Moreover, the SCR 110 includes a P-type substrate 130, an N-type well 140, P+-type doped regions 151-153 and N+-type doped regions 161-162. The N-type well 140 is disposed in the P-type substrate 130. The P+-type doped region 151 is disposed in the N-type well 140, and is electrically connected to the first connection terminal TM1. The N+-type doped region 161 is disposed in the N-type well 140, and is electrically connected to the first control terminal CT1. The P+-type doped region 152 is disposed in the P-type substrate 130, and is electrically connected to the second connection terminal TM2. The N+-type doped region 162 is disposed in the P-type substrate 130, and is electrically connected to the second connection terminal TM2. The P+-type doped region 153 is disposed in the P-type substrate 130, and is located between the P+-type doped region 151 and the N+-type doped region 162, and the P+-type doped region 153 is electrically connected to the second control terminal CT2.

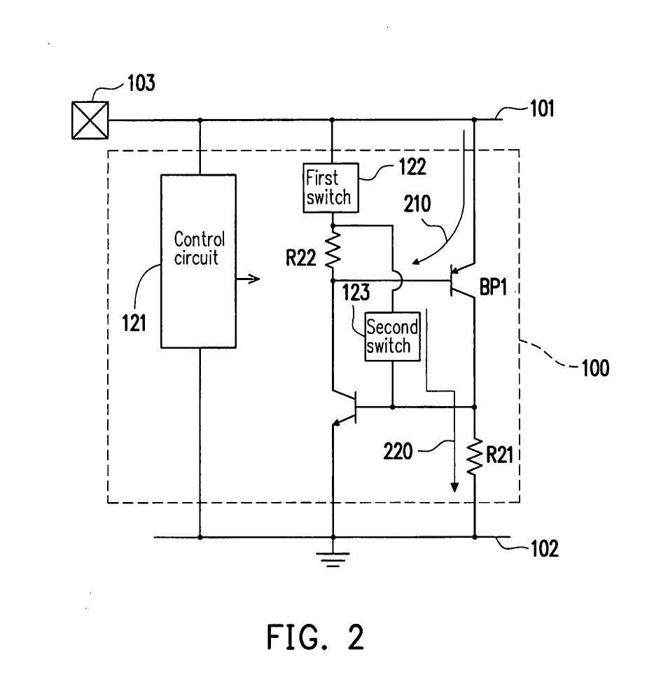

FIG. 2 is an equivalent circuit diagram of an ESD protection device according to an exemplary embodiment of the invention. Referring to FIG. 1 and FIG. 2, the P+-type doped region 151, the N-type well 140 and the P-type substrate 130 in the SCR 110 can form a vertical PNP transistor BP1, and the N-type well 140, the P-type substrate 130 and the N+-type doped region 162 can form a lateral NPN transistor BN1. Moreover, a resistor R21 in FIG. 1 is an equivalent resistor contributed by the P-type substrate 130, and a resistor R22 in FIG. 1 is an equivalent resistor contributed by the N-type well 140. In other words, the SCR 110 can be equivalent to a circuit structure composed of the PNP transistor BP1, the NPN transistor BN1, the resistor R21 and the resistor R22.

In an actual application, the ESD protection device 100 is mainly used to guide an electrostatic pulse come from a pad 103, so as to avoid damage of an integrated circuit (not shown) caused by the electrostatic pulse. For example, when an ESD event occurs, the electrostatic pulse enters through the pad 103, and is appeared on the first line 101. Now, the control circuit 121 turns on the second switch 123 and turns off the first switch 122 in response to the electrostatic pulse. In this way, as shown in FIG. 1, as the second switch 123 is turned on, the electrostatic pulse is directly transmitted to the P+-type doped region 153 in the P-type substrate 130 through the P+-type doped region 151, the N-type well 140, the N+-type doped region 161 and the second switch 123. In this way, the P-N junction formed by the P+-type doped region 151 and the N-type well 140 is in a forward bias, i.e. a base-emitter of the PNP transistor BP1 is biased in the forward bias, which avails turning on the PNP transistor BP1.

Moreover, a base-emitter current of the PNP transistor BP1 can directly flow to the P-type substrate 130 through the turned-on second switch 123, which avails increasing a voltage level of the P-type substrate 130. Namely, shown as current paths 210 and 220 of FIG. 2, the base-emitter current of the PNP transistor BP1 is directly transmitted to the resistor R21 through the resistor R22 and the turned-on second switch 123, so as to form a voltage difference used for turning on the NPN transistor BN1. In other words, the SCR 110 can simultaneously turn on the PNP transistor BP1 and the NPN transistor BN1 without forming an avalanche breakdown current between the N-type well 140 and the P-type substrate 130. In this way, when the ESD event occurs, the SCR 110 can accelerate a turn-on speed thereof as the second switch is turned on, so as to quickly guide the electrostatic pulse to the second line 102 connected to ground.

On the other hand, when the integrated circuit normally operates, the input signal is supplied to the first line 101 through the pad 103. Now, the control circuit 121 turns on the first switch 122 and turns off the second switch 123 in response to the input signal. In this way, the PNP transistor BP1 is in a turn-off state, and a trigger voltage and a holding voltage of the SCR 110 is pulled up to a higher voltage level. Therefore, the SCR 110 is maintained to the turn-off state, so as to avoid generation of leakage current.

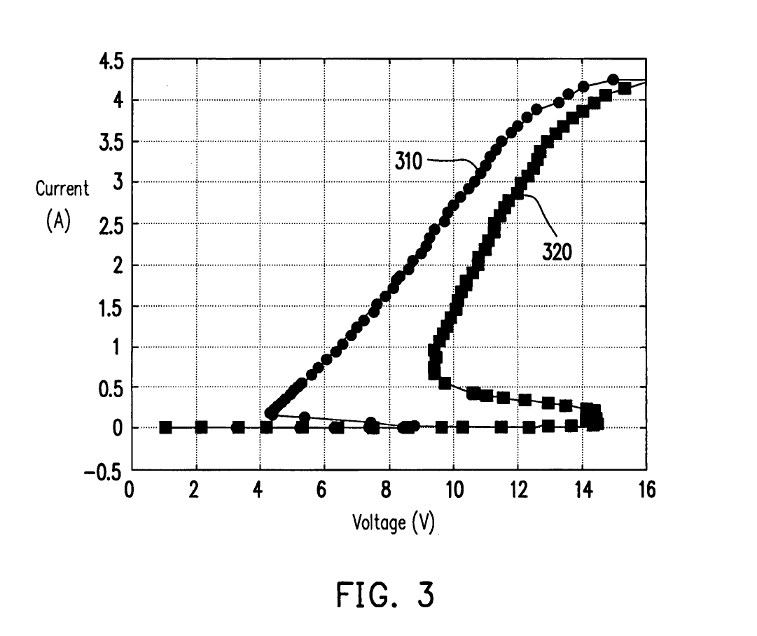

For example, FIG. 3 is a characteristic curve of an SCR according to an exemplary embodiment of the invention. A curve 310 is a voltage-current characteristic curve of the SCR 110 in case that the second switch 123 is turned on and the first switch 122 is turned off, and a curve 320 is a voltage-current characteristic curve of the SCR 110 in case that the first switch 122 is turned on and the second switch 123 is turned off. As shown in the curve 310, when the second switch 123 is turned on and the first switch 122 is turned off, the trigger voltage is pulled down to about 8.8 volts (V), and the holding voltage is pulled down to about 4.3 V. Moreover, as shown in the curve 320, when the first switch 122 is turned on and the second switch 123 is turned off, the trigger voltage is pulled up to about 14.3 V, and the holding voltage is pulled up to about 9.5 V.

In other words, when the electrostatic pulse is appeared on the first line 101, the path switching unit 120 turns off the first switch 122 and turns of the second switch 123, i.e. the path switching unit 120 provides a second current path from the first control terminal CT1 to the second control terminal CT2. In this way, the turn-on speed of the SCR 110 is increased, and the trigger voltage and the holding voltage of the SCR 110 are decreased. Moreover, as the trigger voltage decreases, a non-uniform turn-on phenomenon of a plurality of SCRs in the ESD protection device 100 is mitigated. On the other hand, when the integrated circuit normally operates, i.e. when the input signal is supplied to the first line 101, the path switching unit 120 turns on the first switch 122 and turns off the second switch 123, namely, the path switching unit 120 provides a first current path from the first line 101 to the first control terminal CT1. In this way, the PNP transistor BP1 is turned off, and the trigger voltage and the holding voltage of the SCR 110 are increased to avoid generation of the leakage current.

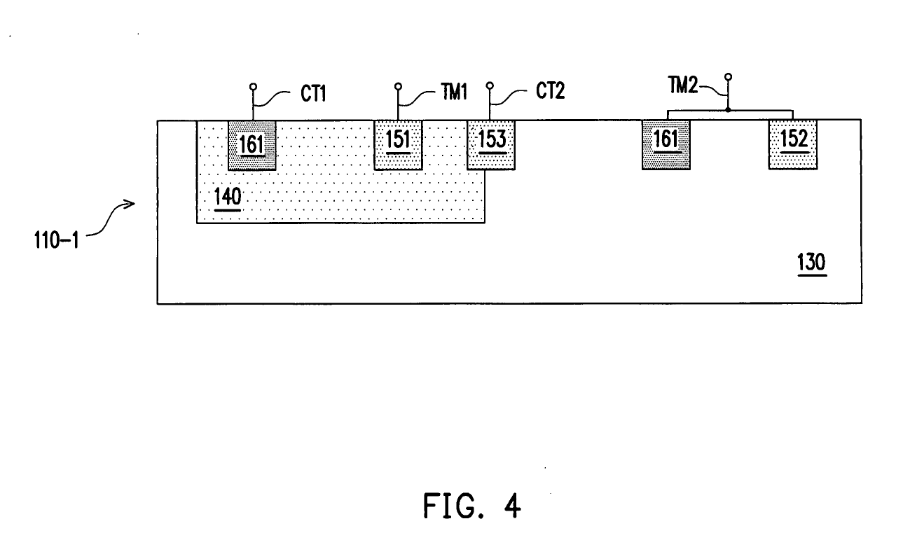

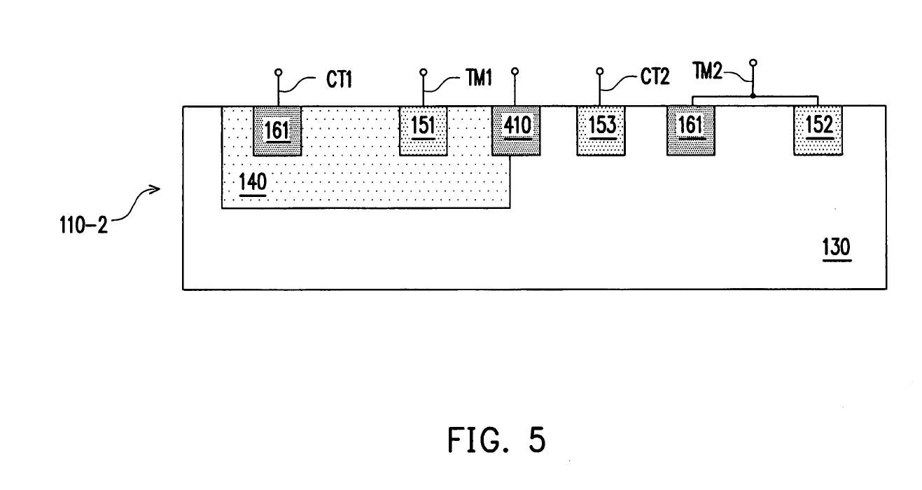

It should be noticed that although the embodiment of FIG. 1 provides an implementation of the SCR 110, it is not used to limit the invention. For example, FIGS. 4-5 are respectively a structural schematic diagram of an SCR according to an exemplary embodiment of the invention. As shown in FIG. 4, the SCR 110-1 of the ESD protection device 100 is, for example, a modified lateral SCR (MLSCR). Referring to FIG. 1 and FIG. 4, a main difference between the two SCRs 110 and 110-1 is that the P+-type doped region 153 of FIG. 1 is disposed in the P-type substrate 130, and the P+-type doped region 153 of FIG. 4 is partially disposed in the N-type well 140. Moreover, as shown in FIG. 5, the SCR 110-2 of the ESD protection device 100 is, for example, another MLSCR. Referring to FIG. 1 and FIG. 5, a main difference between the two SCRs 110 and 110-2 is that the SCR 110-2 further includes an N+-type doped region 410, and the N+-type doped region 410 is partially disposed in the N-type well 140.

In order to fully convey the spirit of the exemplary embodiments of the invention to those skilled in the art, the circuit structure of the path switching unit is described below. For simplicity's sake, two terminals of the first switch 122 and the second switch 123 are respectively indicated as A1, A2, B1 and B2 in FIG. 1, and A1, A2, B1 and B2 are all indicated in the following circuit schematic diagrams of the path switching unit, so as to indicate the connection relation of the first switch 122 and the second switch 123 in the embodiment of FIG. 1.

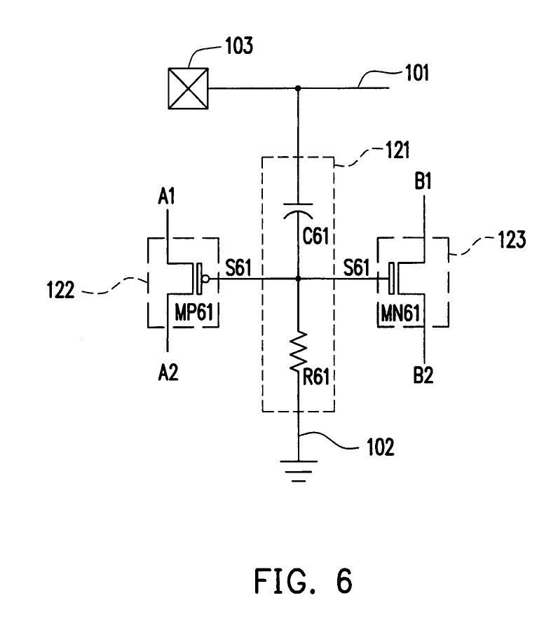

FIGS. 6-8 are circuit schematic diagrams of path switching units according to an exemplary embodiment of the invention. Referring to FIG. 6, the control circuit 121 includes a capacitor C61 and a resistor R61. A first terminal of the capacitor C61 is electrically connected to the first line 101. A first terminal of the resistor R61 is electrically connected to a second terminal of the capacitor C61, and a second terminal of the resistor R61 is electrically connected to the second line 102. Moreover, the first switch 122 is composed of a P-type transistor MP61, and the second switch 123 is composed of an N-type transistor MN61.

In view of operation, the capacitor C61 and the resistor R61 that are connected in series are equivalent to a high-pass filter, and the second terminal of the capacitor C61 generates a first control signal S61. In this way, when the electrostatic pulse is appeared on the first line 101, the control circuit 121 is equivalent to receive a high-frequency signal, and switches a level of the first control signal S61 to a high voltage level. Moreover, the first control signal S61 with the high voltage level turns on the N-type transistor MN61, and maintains the P-type transistor MP61 in the turn-off state. On the other hand, when the input signal is supplied to the first line 101, the control circuit 121 is equivalent to receive a low-frequency signal, and switches the level of the first control signal S61 to a low voltage level. Moreover, the first control signal S61 with the low voltage level turns on the P-type transistor MP61, and maintains the N-type transistor MN61 in the turn-off state.

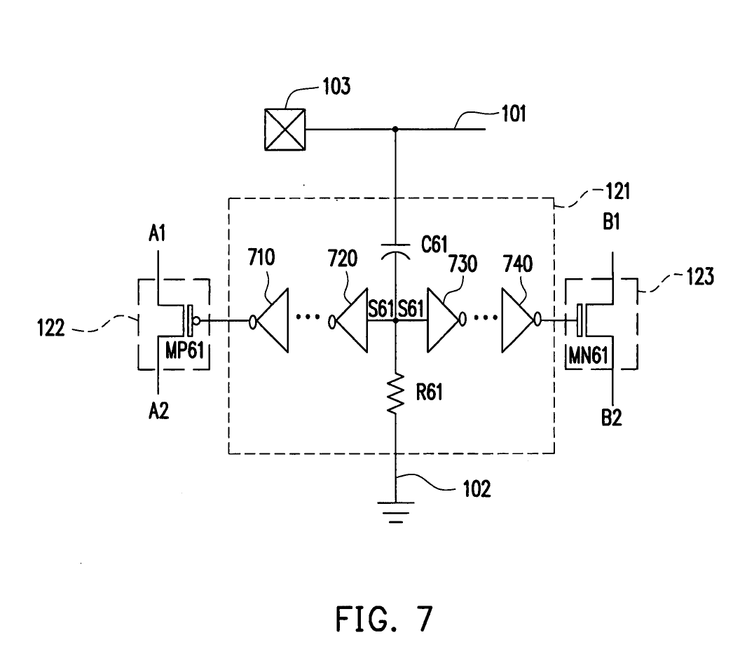

The path switching unit of FIG. 7 is an extension of the path switch unit of FIG. 6, and a main difference between the two embodiments of FIG. 7 and FIG. 6 is that the control circuit 121 of FIG. 7 further includes inverters 710-740. As shown in FIG. 7, an even number of inverters 710-720 are connected in series between the second terminal of the capacitor C61 and the first switch 122, and an even number of inverters 730-740 are connected in series between the second terminal of the capacitor C61 and the second switch 123. In other words, after the first control signal S61 is respectively inverted by the even number of times, it is transmitted to the first switch 122 and the second switch 123. Therefore, a level of the signal transmitted to the first switch 122 and the second switch 123 is still the same to the level of the first control signal S61. In other words, in the embodiment of FIG. 7, when the electrostatic pulse is appeared on the first line 101, the P-type transistor MP61 and the N-type transistor MN61 still respectively receive the signal with the high voltage level. Moreover, when the input signal is supplied to the first line 101, the P-type transistor MP61 and the N-type transistor MN61 still respectively receive the signal with the low voltage level. Detailed operations of the embodiment of FIG. 7 are similar to that of the embodiment of FIG. 6, which are not repeated.

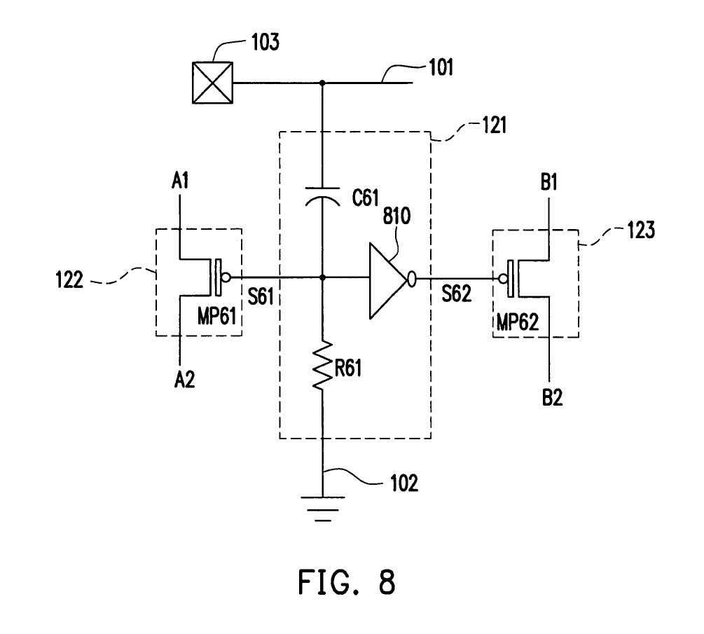

The path switching unit of FIG. 8 is an extension of the path switch unit of FIG. 6, and a main difference between the two embodiments of FIG. 8 and FIG. 6 is that the control circuit 121 of FIG. 8 further includes an inverters 810, and the second switch 123 of FIG. 8 is composed of a P-type transistor MP62. As shown in FIG. 8, an input terminal of the inverter 810 receives the first control signal S61, and an output terminal of the inverter 810 generates a second control signal S62. In other words, the first control signal S61 and the second control signal S62 are two control signals inverted to each other. Moreover, in the embodiment of FIG. 8, the first switch 122 and the second switch 123 are respectively composed of a P-type transistor, and are used to receive the two control signals S61 and S62 inverted to each other. Therefore, when the P-type transistor MP61 is turned on, the P-type transistor MP62 is maintained to the turn-off state. Comparatively, when the P-type transistor MP61 is not turned on, the P-type transistor MP62 is maintained to the turn-on state. Detailed operations of the embodiment of FIG. 8 are similar to that of the embodiment of FIG. 6, which are not repeated.

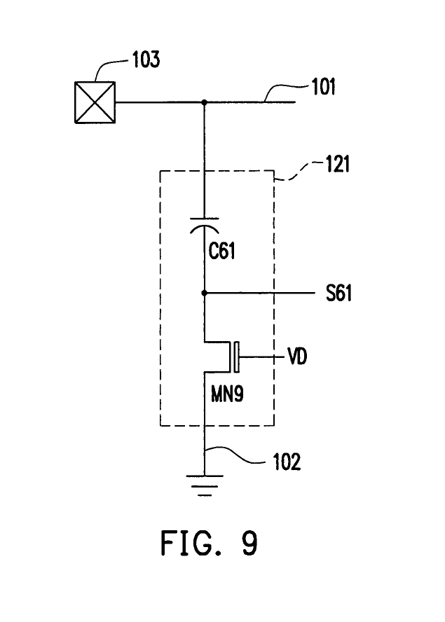

It should be noticed that similar to the embodiment of FIG. 7, the even number of inverters can also be connected in series between the second terminal of the capacitor C61 of FIG. 8 and the first switch 122, or the even number of inverters can be connected in series between the output terminal of the inverter 810 of FIG. 8 and the second switch 123. Moreover, in an actual application, the resistor R61 of the control circuit 121 in FIGS. 6-8 can be respectively implemented by a transistor. For example, FIG. 9 is a schematic diagram of a control circuit according to an exemplary embodiment of the invention. Referring to FIG. 9, the control circuit 121 includes the capacitor C61 and an N-type transistor MN9. The N-type transistor MN9 and the capacitor C61 are connected in series between the first line 101 and the second line 102, and a gate of the N-type transistor MN9 receives a power voltage VD. In this way, when the electrostatic pulse is appeared on the first line 101, the gate of the N-type transistor MN9 cannot receive the power voltage VD, and then the N-type transistor MN9 is in the turn-off state. Moreover, the turned-off N-type transistor MN9 is equivalent to a large resistor, and the capacitor C61 transmits the electrostatic pulse to increase the level of the first control signal S61. On the other hand, when the input signal is supplied to the first line 101, the gate of the N-type transistor MN9 can receive the power voltage VD, and the N-type transistor MN9 is in the turn-on state. Moreover, the capacitor C61 now blocks the input signal, and the level of the first control signal S61 is pulled down to the low voltage level through the turned-on N-type transistor MN9.

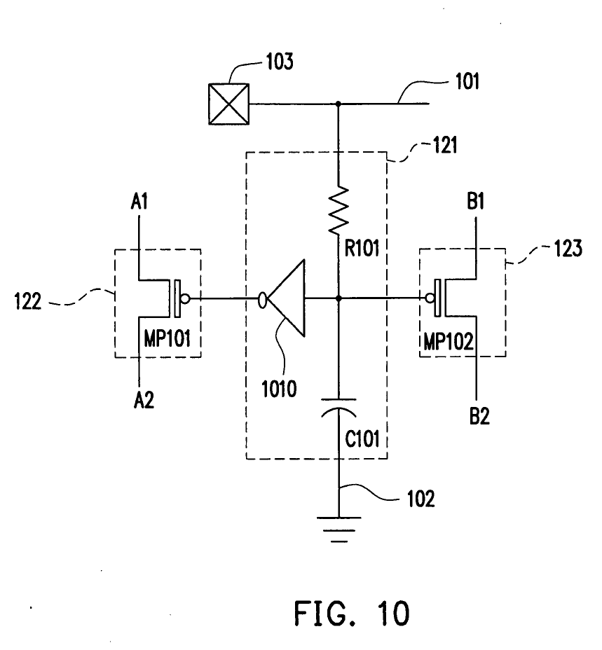

FIG. 10 is a circuit schematic diagram of a path switching unit according to another exemplary embodiment of the invention. Referring to FIG. 10, the control circuit 121 includes a resistor R101, a capacitor C101 and an inverter 1010. A first terminal of the resistor R101 is electrically connected to the first line 101, and a second terminal of the resistor R101 generates a first control signal S101. A first terminal of the capacitor C101 is electrically connected to the second terminal of the resistor R101, and a second terminal of the capacitor C101 is electrically connected to the second line 102. An input terminal of the inverter 1010 receives the first control signal S101, and an output terminal of the inverter 1010 generates a second control signal S102. Moreover, the first switch 122 is composed of a P-type transistor MP101, and the second switch 123 is composed of a P-type transistor MP102.

In view of operation, the resistor R101 and the capacitor C101 that are connected in series are equivalent to a low-pass filter. In this way, when the electrostatic pulse is appeared on the first line 101, the control circuit 121 is equivalent to receive a high-frequency signal, and switches a level of the first control signal S101 to the low voltage level. Moreover, the inverter 1010 switches the level of the second control signal S102 to the high voltage level according to the first control signal S101 with the low voltage level. Comparatively, the P-type transistor MP101 in the first switch 122 is in the turn-off state in response to the second control signal S102 with the high voltage level. Moreover, the P-type transistor MP102 in the second switch 123 is in the turn-on state in response to the first control signal S101 with the low voltage level. On the other hand, when the input signal is supplied to the first line 101, the control circuit 121 is equivalent to receive a low-frequency signal, and switches the level of the first control signal S101 to the high voltage level, and the inverter 1010 accordingly generates the second control signal S102 with the low voltage level. Therefore, the P-type transistor MP101 in the first switch 122 is in the turn-on state, and the P-type transistor MP102 in the second switch 123 is in the turn-off state.

It should be noticed that in an actual application, similar to the embodiment of FIG. 6, an N-type transistor can be used to implement the second switch 123 of FIG. 10, and another inverter can be added between the second terminal of the resistor R101 and the second switch 123. Moreover, similar to the embodiment of FIG. 7, the even number of inverters can also be connected in series between the second terminal of the resistor R101 of FIG. 10 and the second switch 123, or the even number of inverters can be connected in series between the output terminal of the inverter 1010 of FIG. 10 and the first switch 122. Moreover, similar to the embodiment of FIG. 9, the resistor R101 in the control circuit 121 of FIG. 10 can also be implemented by a transistor.

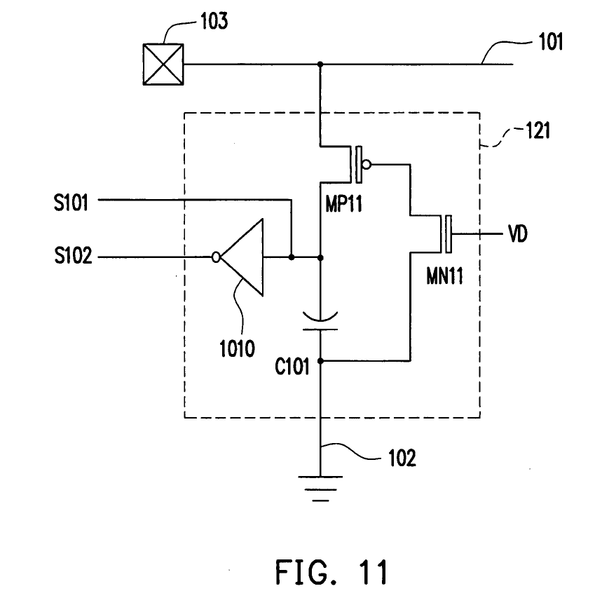

For example, FIG. 11 is a schematic diagram of a control circuit according to another exemplary embodiment of the invention. Referring to FIG. 11, the control circuit 121 includes a P-type transistor MP11, an N-type transistor MN11 and a capacitor C101. The P-type transistor MP11 and the capacitor C101 are connected in series between the first line 101 and the second line 102. The N-type transistor MN11 is electrically connected between a gate of the P-type transistor MP11 and the second line 102, and a gate of the N-type transistor MN11 receives a power voltage VD. In this way, when the electrostatic pulse is appeared on the first line 101, the gate of the N-type transistor MN11 cannot receive the power voltage VD, and the gate of the P-type transistor MP11 is coupled to the first line 101 through a parasitic capacitor between the gate and the source of the P-type transistor MP11, so that the N-type transistor MN11 and the P-type transistor MP11 are all in the turn-off state. Moreover, the turned-off P-type transistor MP11 is equivalent to a large resistor, and pulls down the level of the first control signal S101 to the low voltage level. On the other hand, when the input signal is supplied to the first line 101, the gate of the N-type transistor MN11 can receive the power voltage VD, and the N-type transistor MN11 and the P-type transistor MP11 are all in the turn-on state. Moreover, as the P-type transistor MP11 is turned on, the level of the first control signal S101 is increased to the high voltage level.

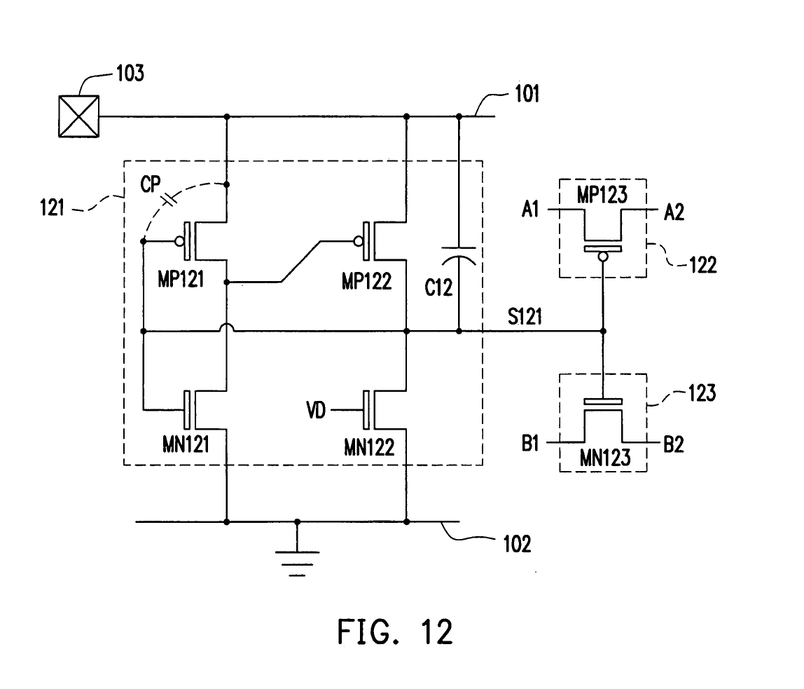

FIGS. 12-16 are respectively a circuit schematic diagram of a path switching unit according to still another exemplary embodiment of the invention. Referring to FIG. 12, the control circuit 121 includes a P-type transistor MP121, a P-type transistor MP122, an N-type transistor MN121, an N-type transistor MN122 and a capacitor C12. A source of the P-type transistor MP121 is electrically connected to the first line 101. A drain of the N-type transistor MN121 is electrically connected to a drain of the P-type transistor MP121, a gate of the N-type transistor MN121 is electrically connected to a gate of the P-type transistor MP121, and a source of the N-type transistor MN121 is electrically connected to the second line 102. A source of the P-type transistor MP122 is electrically connected to the first line 101, a gate of the P-type transistor MP122 is electrically connected to the drain of the P-type transistor MP121, and a drain of the P-type transistor MP122 generates a first control signal S121 and is electrically connected to the gate of the P-type transistor MP121. A drain of the N-type transistor MN122 is electrically connected to the drain of the P-type transistor MP122, a gate of the N-type transistor MN122 receives the power voltage VD, and a source of the N-type transistor MN122 is electrically connected to the second line 102. Moreover, the first switch 122 is composed of a P-type transistor MP123, and the second switch 123 is composed of an N-type transistor MN123.

In view of operation, when the electrostatic pulse is appeared on the first line 101, the gate of the N-type transistor MN122 cannot receive the power voltage VD, and is in a floating state, such that the N-type transistor MN122 is not turned on. Moreover, the electrostatic pulse is coupled to the drain of the P-type transistor MP121 through the capacitor C12, so as to switch the level of the first control signal S121 to the high voltage level. Moreover, the electrostatic pulse is also coupled to the gate of the P-type transistor MP121 and the N-type transistor MN121 through the capacitor C12, such that the N-type transistor MN121 is turned on, and the P-type transistor MP121 is in the turn-off state. Further, as the N-type transistor MN121 is turned on, the P-type transistor MP122 is latched to the turn-on state. On the other hand, the first control signal 5121 with the high voltage level turns on the N-type transistor MN123 of the second switch 123, and maintains the P-type transistor MP123 of the first switch 122 in the turn-off state.

When the integrated circuit normally operates, the input signal is supplied to the first line 101 through the pad 103. Moreover, the gate of the N-type transistor MN122 can receive the power voltage VD, such that the N-type transistor MN122 is in the turn-on state. In this way, as the N-type transistor MN122 is turned on, the level of the first control signal S121 is switched to the low voltage level. Moreover, the gate of the P-type transistor MP121 and the gate of the N-type transistor MN121 are coupled to a ground through the turned-on N-type transistor MN122, such that the P-type transistor MP121 is turned on, and the N-type transistor MN121 is in the turn-off state. As the P-type transistor MP121 is turned on, the P-type transistor MP122 is latched to the turn-off state. Moreover, the first control signal S121 with the low voltage level turns on the P-type transistor MP123 of the first switch 122, and maintains the N-type transistor MN123 of the second switch 123 to the turn-off state.

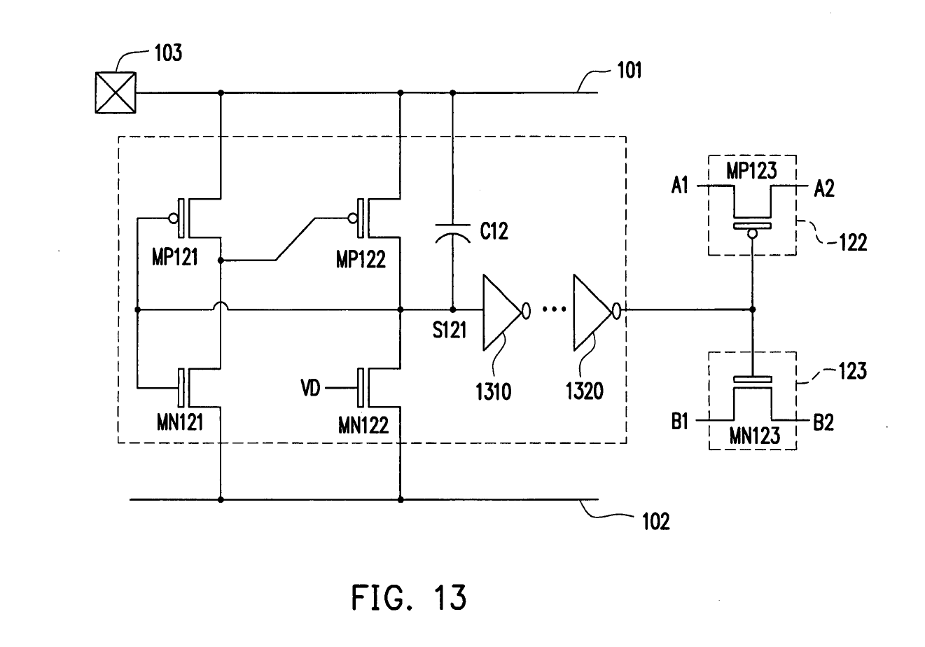

The path switching unit of FIG. 13 is an extension of the path switch unit of FIG. 12, and a main difference between the two embodiments of FIG. 13 and FIG. 12 is that the control circuit 121 of FIG. 13 further includes inverters 1310-1320. As shown in FIG. 13, the even number of inverters 1310-1320 are connected in series between the drain of the P-type transistor MP122 and the first switch 122. In other words, after the first control signal S121 is inverted by the even number of times, it is transmitted to the first switch 122 and the second switch 123. Therefore, a level of the signal transmitted to the first switch 122 and the second switch 123 is still the same to the level of the first control signal S121.

In this way, in the embodiment of FIG. 13, when the electrostatic pulse is appeared on the first line 101, the gate of the P-type transistor MP123 and the gate of the N-type transistor MN123 still respectively receive the signal with the high voltage level, such that the N-type transistor MN123 is turned on, and the P-type transistor MP123 is in the turn-off state. Moreover, when the input signal is supplied to the first line 101, the gate of the P-type transistor MP123 and the gate of the N-type transistor MN123 still respectively receive the signal with the low voltage level, such that the P-type transistor MP123 is turned on, and the N-type transistor MN123 is in the turn-off state. Detailed operations of the embodiment of FIG. 13 are similar to that of the embodiment of FIG. 12, which are not repeated.

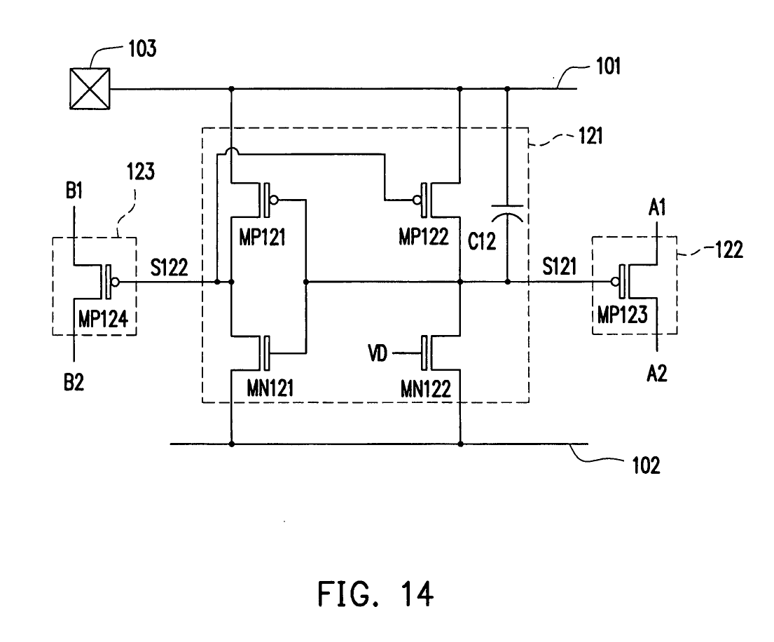

The path switching unit of FIG. 14 is an extension of the path switch unit of FIG. 12, and a main difference between the two embodiments of FIG. 14 and FIG. 12 is that the control circuit 121 of FIG. 14 further generates the second control signal S122 through the drain of the P-type transistor MP121, and the second switch 123 is composed of a P-type transistor MP124. As shown in FIG. 14, the first control signal S121 and the second control signal S122 are two control signals inverted to each other. Moreover, in the embodiment of FIG. 14, the first switch 122 and the second switch 123 are respectively composed of a P-type transistor. Therefore, when the P-type transistor MP123 is turned on, the P-type transistor MP124 is maintained to the turn-off state. Comparatively, when the P-type transistor MP123 is not turned on, the P-type transistor MP124 is maintained to the turn-on state. Detailed operations of the embodiment of FIG. 14 are similar to that of the embodiment of FIG. 12, which are not repeated.

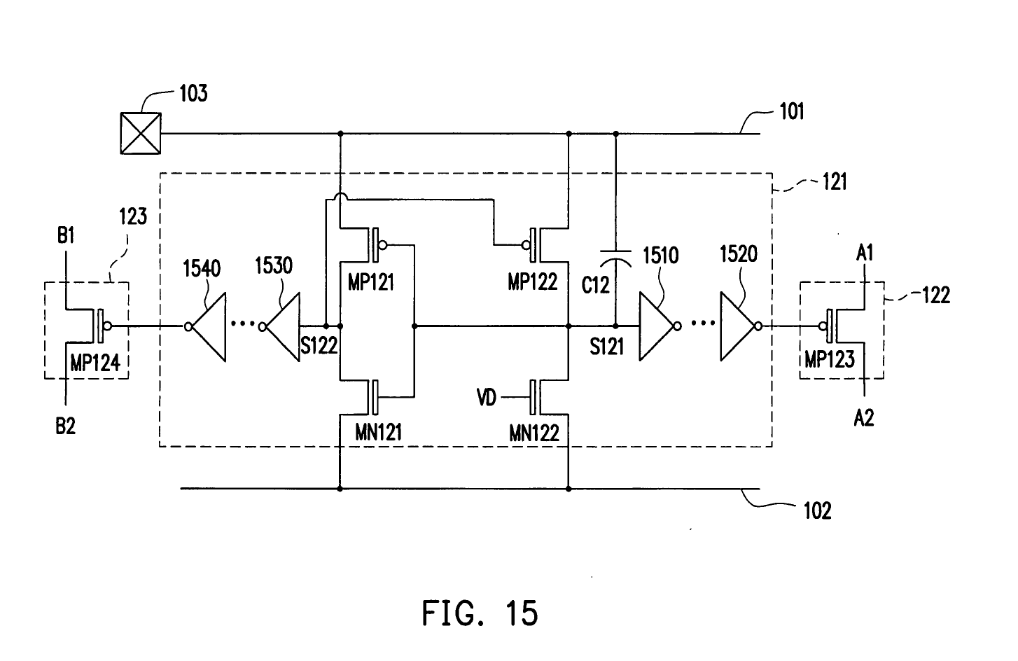

The path switching unit of FIG. 15 is an extension of the path switch unit of FIG. 14, and a main difference between the two embodiments of FIG. 15 and FIG. 14 is that the control circuit 121 of FIG. 15 further includes inverters 1510-1540. As shown in FIG. 15, an even number of inverters 1510-1520 are connected in series between the drain of the P-type transistor MP122 and the first switch 122, and an even number of inverters 1530-1540 are connected in series between the drain of the P-type transistor MP121 and the second switch 123. Therefore, a level of the signal transmitted to the first switch 121 is still the same to the level of the first control signal S121, and a level of the signal transmitted to the second switch 122 is still the same to the level of the second control signal S122. Detailed operations of the embodiment of FIG. 15 are similar to that of the embodiment of FIG. 14, which are not repeated.

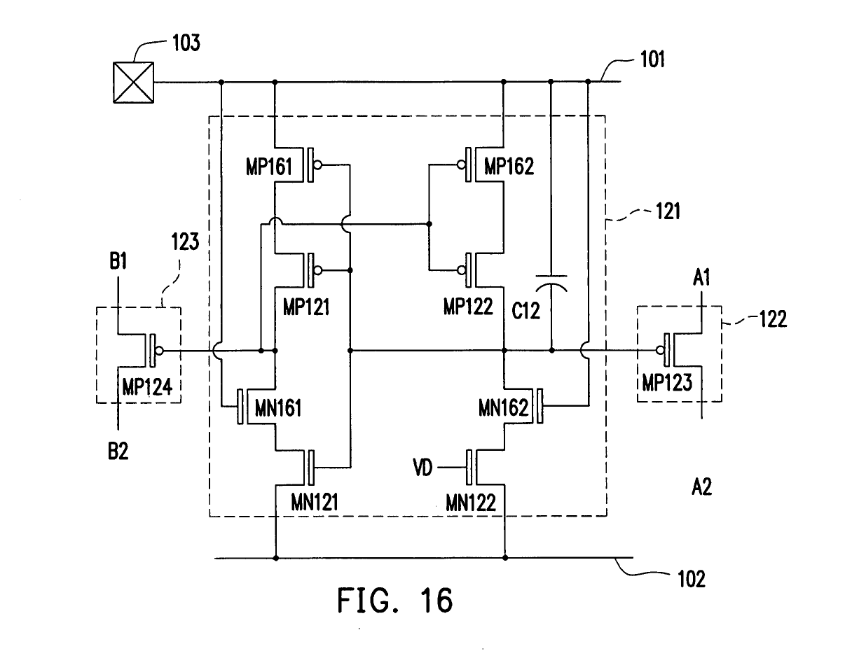

The path switching unit of FIG. 16 is an extension of the path switch unit of FIG. 14, and a main difference between the two embodiments of FIG. 16 and FIG. 14 is that the control circuit 121 of FIG. 16 further includes a P-type transistor MP161, a P-type transistor MP162, an N-type transistor MN161 and an N-type transistor MN162. The P-type transistor MP161 is connected in cascade with the P-type transistor MP121 and the P-type transistor MP162 is connected in cascade with the P-type transistor MP122. Similarly, the N-type transistor MN161 is connected in cascade with the N-type transistor MN121, and the N-type transistor MN162 is connected in cascade with the N-type transistor MN122. In this way, the P-type transistor MP161, the P-type transistor MP121, the N-type transistor MN161 and the N-type transistor MN121 are connected in cascade between the first line 101 and the second line 102, and the P-type transistor MP162, the P-type transistor MP122, the N-type transistor MN162 and the N-type transistor MN122 are connected in cascade between the first line 101 and the second line 102, so that the path switching unit 120 can be applied in a high voltage.

It should be noticed that in an actual application, the capacitor C12 in the control circuit 121 of FIGS. 12-16 can be replaced by a parasitic capacitor CP between the gate and the source of the P-type transistor MP121. In other words, the capacitor C12 in the control circuit 121 of FIGS. 12-16 can be selectively removed according to a design requirement.

In summary, the path switching unit is used to control the current paths of the SCR, such that the SCR can simultaneously turn on the PNP transistor and the NPN transistor in internal of the SCR without forming an avalanche breakdown current between the N-type well and the P-type substrate. In other words, when an ESD event occurs, a turn-on speed of the SCR is accelerated under control of the path switching unit, which avails improving protection performance of the ESD protection device. Moreover, when the ESD event occurs, the SCR also decreases the trigger voltage and the holding voltage under control of the path switching unit. In this way, as the trigger voltage decreases, a non-uniform turn-on phenomenon of a plurality of SCRs in the ESD protection device is mitigated.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An electrostatic discharge protection device, comprising:
a silicon-controlled rectifier, comprising a first connection terminal, a second connection terminal, a first control terminal and a second control terminal, wherein the first connection terminal and the second connection terminal are respectively connected to a first line and a second line; and
a path switching unit, electrically connected to the first line, the first control terminal and the second control terminal, wherein when an input signal is supplied to the first line, the path switching unit provides a first current path from the first line to the first control terminal in response to the input signal, and when an electrostatic pulse is appeared on the first line, the path switching unit provides a second current path from the first control terminal to the second control terminal in response to the electrostatic pulse.

2. The electrostatic discharge protection device as claimed in claim 1, wherein the path switching unit comprises:
a first switch, electrically connected between the first line and the first control terminal;
a second switch, electrically connected between the first control terminal and the second control terminal; and
a control circuit, electrically connected to the first line, the second line, the first switch and the second switch,
wherein the control circuit turns on the second switch and turns off the first switch in response to the electrostatic pulse so as to provide the second current path through the second switch, and the control circuit turns on the first switch and turns off the second switch in response to the input signal so as to provide the first current path through the first switch.

3. The electrostatic discharge protection device as claimed in claim 2, wherein the control circuit comprises:
a capacitor, having a first terminal electrically connected to the first line; and
a resistor, having a first terminal electrically connected to a second terminal of the capacitor, and a second terminal electrically connected to the second line, wherein the control circuit generates a first control signal through the second terminal of the capacitor.

4. The electrostatic discharge protection device as claimed in claim 3, wherein the first switch and the second switch are respectively composed of a P-type transistor and an N-type transistor, and the P-type transistor and the N-type transistor are respectively controlled by the first control signal.

5. The electrostatic discharge protection device as claimed in claim 3, wherein the control circuit further comprises an inverter, an input terminal of the inverter receives the first control signal, and an output terminal of the inverter generates a second control signal.

6. The electrostatic discharge protection device as claimed in claim 5, wherein the first switch and the second switch are respectively composed of a first P-type transistor and a second P-type transistor, the first P-type transistor is controlled by the first control signal, and the second P-type transistor is controlled by the second control signal.

7. The electrostatic discharge protection device as claimed in claim 2, wherein the control circuit comprises:
a resistor, having a first terminal electrically connected to the first line, and a second terminal generating a first control signal;
a capacitor, having a first terminal electrically connected to a second terminal of the resistor, and a second terminal electrically connected to the second line; and
an inverter, having an input terminal receiving the first control signal, and an output terminal generating a second control signal.

8. The electrostatic discharge protection device as claimed in claim 7, wherein the first switch and the second switch are respectively composed of a first P-type transistor and a second P-type transistor, the first P-type transistor is controlled by the second control signal, and the second P-type transistor is controlled by the first control signal.

9. The electrostatic discharge protection device as claimed in claim 2, wherein the control circuit comprises:
a first P-type transistor, having a source electrically connected to the first line;
a first N-type transistor, having a drain electrically connected to a drain of the first P-type transistor, a gate electrically connected to a gate of the first P-type transistor, and a source electrically connected to the second line;
a second P-type transistor, having a source electrically connected to the first line, a gate electrically connected to the drain of the first P-type transistor, and a drain generating a first control signal and electrically connected to the gate of the first P-type transistor; and
a second N-type transistor, having a drain electrically connected to the drain of the second P-type transistor, a gate receiving a power voltage, and a source electrically connected to the second line.

10. The electrostatic discharge protection device as claimed in claim 9, wherein the first switch and the second switch are respectively composed of a P-type transistor and an N-type transistor, and the P-type transistor and the N-type transistor are respectively controlled by the first control signal.

11. The electrostatic discharge protection device as claimed in claim 9, wherein the drain of the first P-type transistor generates a second control signal, the first switch and the second switch are respectively composed of a first P-type transistor and a second P-type transistor, the first P-type transistor is controlled by the first control signal, and the second P-type transistor is controlled by the second control signal.

12. The electrostatic discharge protection device as claimed in claim 9, wherein the control circuit further comprises a capacitor, a first terminal of the capacitor is electrically connected to the first line, and a second terminal of the capacitor is electrically connected to the gate of the first P-type transistor.

13. The electrostatic discharge protection device as claimed in claim 1, wherein the silicon-controlled rectifier comprises:
a P-type substrate;
an N-type well, disposed in the P-type substrate;
a first P+-type doped region, disposed in the N-type well, and electrically connected to the first connection terminal;
a first N+-type doped region, disposed in the N-type well, and electrically connected to the first control terminal;
a second P+-type doped region, disposed in the P-type substrate, and electrically connected to the second connection terminal;
a second N+-type doped region, disposed in the P-type substrate, and electrically connected to the second connection terminal; and
a third P+-type doped region, disposed in the P-type substrate, located between the first P+-type doped region and the second N+-type doped region, and electrically connected to the second control terminal.

14. The electrostatic discharge protection device as claimed in claim 13, wherein the silicon-controlled rectifier further comprises a third N+-type doped region, and the third N+-type doped region is partially disposed in the N-type well.

15. The electrostatic discharge protection device as claimed in claim 1, wherein the silicon-controlled rectifier comprises:
a P-type substrate;
an N-type well, disposed in the P-type substrate;
a first P+-type doped region, disposed in the N-type well, and electrically connected to the first connection terminal;
a first N+-type doped region, disposed in the N-type well, and electrically connected to the first control terminal;
a second P+-type doped region, disposed in the P-type substrate, and electrically connected to the second connection terminal;
a second N+-type doped region, disposed in the P-type substrate, and electrically connected to the second connection terminal; and
a third P+-type doped region, partially disposed in the N-type well, and electrically connected to the second control terminal.

16. An electrostatic discharge protection device, comprising:
a silicon-controlled rectifier, comprising a first connection terminal, a second connection terminal, a first control terminal and a second control terminal, wherein the first connection terminal and the second connection terminal are respectively connected to a first line and a second line; and
a path switching unit, comprising a first switch connected between the first line and the first control terminal and a second switch connected between the first control terminal and the second control terminal, wherein when an input signal is supplied to the first line, the path switching unit turns on the first switch and turns off the second switch, and when an electrostatic pulse is appeared on the first line, the path switching unit turns off the first switch and turns on the second switch.

17. The electrostatic discharge protection device as claimed in claim 16, wherein the path switching unit further comprises:
a control circuit, electrically connected to the first line, the second line, the first switch and the second switch, wherein the control circuit turns on the second switch and turns off the first switch in response to the electrostatic pulse, and the control circuit turns on the first switch and turns off the second switch in response to the input signal.

18. The electrostatic discharge protection device as claimed in claim 17, wherein the control circuit comprises:
a capacitor, having a first terminal electrically connected to the first line; and
a resistor, having a first terminal electrically connected to a second terminal of the capacitor, and a second terminal electrically connected to the second line, wherein the control circuit generates a first control signal through the second terminal of the capacitor.

19. The electrostatic discharge protection device as claimed in claim 18, wherein the first switch and the second switch are respectively composed of a P-type transistor and an N-type transistor, and the P-type transistor and the N-type transistor are respectively controlled by the first control signal.

20. The electrostatic discharge protection device as claimed in claim 17, wherein the control circuit comprises:
a resistor, having a first terminal electrically connected to the first line, and a second terminal generating a first control signal;
a capacitor, having a first terminal electrically connected to a second terminal of the resistor, and a second terminal electrically connected to the second line; and
an inverter, having an input terminal receiving the first control signal, and an output terminal generating a second control signal.

21. The electrostatic discharge protection device as claimed in claim 20, wherein the first switch and the second switch are respectively composed of a first P-type transistor and a second P-type transistor, the first P-type transistor is controlled by the second control signal, and the second P-type transistor is controlled by the first control signal.

22. The electrostatic discharge protection device as claimed in claim 17, wherein the control circuit comprises:
a first P-type transistor, having a source electrically connected to the first line;
a first N-type transistor, having a drain electrically connected to a drain of the first P-type transistor, a gate electrically connected to a gate of the first P-type transistor, and a source electrically connected to the second line;
a second P-type transistor, having a source electrically connected to the first line, a gate electrically connected to the drain of the first P-type transistor, and a drain generating a first control signal and electrically connected to the gate of the first P-type transistor; and
a second N-type transistor, having a drain electrically connected to the drain of the second P-type transistor, a gate receiving a power voltage, and a source electrically connected to the second line.

23. The electrostatic discharge protection device as claimed in claim 22, wherein the first switch and the second switch are respectively composed of a P-type transistor and an N-type transistor, and the P-type transistor and the N-type transistor are respectively controlled by the first control signal.

24. The electrostatic discharge protection device as claimed in claim 16, wherein the silicon-controlled rectifier comprises:
a P-type substrate;
an N-type well, disposed in the P-type substrate;
a first P+-type doped region, disposed in the N-type well, and electrically connected to the first connection terminal;
a first N+-type doped region, disposed in the N-type well, and electrically connected to the first control terminal;
a second P+-type doped region, disposed in the P-type substrate, and electrically connected to the second connection terminal;
a second N+-type doped region, disposed in the P-type substrate, and electrically connected to the second connection terminal; and
a third P+-type doped region, disposed in the P-type substrate, located between the first P+-type doped region and the second N+-type doped region, and electrically connected to the second control terminal.

25. The electrostatic discharge protection device as claimed in claim 16, wherein the silicon-controlled rectifier comprises:
a P-type substrate;
an N-type well, disposed in the P-type substrate;
a first P+-type doped region, disposed in the N-type well, and electrically connected to the first connection terminal;
a first N+-type doped region, disposed in the N-type well, and electrically connected to the first control terminal;
a second P+-type doped region, disposed in the P-type substrate, and electrically connected to the second connection terminal;
a second N+-type doped region, disposed in the P-type substrate, and electrically connected to the second connection terminal; and
a third P+-type doped region, partially disposed in the N-type well, and electrically connected to the second control terminal.
